(19) United States
(12) Patent Application Publication
(10) Pub. No.: US 2026/0051045 A1
(43) Pub. Date: Feb. 19, 2026

(54) ROAD SURFACE DIAGNOSIS SYSTEM, ROAD SURFACE DIAGNOSIS METHOD, AND RECORDING MEDIUM

(71) Applicant: NEC Corporation, Minato-ku, Tokyo (JP)

(72) Inventors: Yuta SHIMIZU, Tokyo (JP); Chisato SUGAWARA, Tokyo (JP); Yusuke MIZUKOSHI, Tokyo (JP); Yoshihiro NISHIKAWA, Tokyo (JP)

(73) Assignee: NEC Corporation, Minato-ku, Tokyo (JP)

(21) Appl. No.: 19/105,201

(22) PCT Filed: Oct. 27, 2022
(86) PCT No.: PCT/JP2022/040216

§ 371 Date: Feb. 20, 2025

(51) Int. Cl. G06T 7/00; G06F 3/04817; G06T 3/60

(52) U.S. Cl. CPC G06T 7/001; G06F 3/04817; G06T 3/60; G06T 2200/24; G06T 2207/30184; G06T 2207/30252

(57) ABSTRACT

A road surface diagnosis system according to an aspect of the present disclosure includes: at least one memory storing instructions; and at least one processor configured to execute the instructions to: acquire a plurality of road surface images; recognize road surface deterioration from each of the acquired road surface images; convert at least one of the plurality of road surface images; compare the plurality of road surface images in each of which the road surface at the identical site is imaged, the plurality of road surface images including the converted road surface image, and determine whether road surface deterioration recognized from the road surface images is an identical road surface deterioration; and display, based on the determination, information of the recognized road surface deterioration as information indicating one road surface deterioration or information indicating different road surface deterioration.

### TECHNICAL FIELD

The present disclosure relates to a road surface diagnosis system and the like.

### BACKGROUND ART

Deterioration such as cracking, pot holes, rutting and the like occurs on a paved road due to factors such as traveling of a vehicle and rainfall. Therefore, in order to grasp the deterioration state of the road and plan repair of the road, the state of the road is analyzed.

There is provided a service for recognizing road surface deterioration from an image and indicating the recognized road surface deterioration on a road surface image or a map. PTL 1 discloses a technique of indicating a position where a detection image in which damage of a road surface is detected is captured on a map. The technique of PTL 1 determine whether the captured road surfaces are damaged at the identical place using position information obtained by capturing a plurality of images.

### CITATION LIST

### Patent Literature

PTL 1: JP 7025080 B1

### SUMMARY OF INVENTION

### Technical Problem

The appearance of road surface deterioration varies depending on the imaging direction. Therefore, the road surface deterioration recognized from the plurality of images obtained by imaging the identical place from different directions can be recognized as different road surface deterioration. When the information indicating each of the road surface deterioration recognized to be different is presented, it is difficult to grasp the actual state of the road surface.

An object of the present disclosure is to provide a road surface diagnosis system and the like that facilitate accurate diagnosis of a state of a road surface even when the road surface is imaged from a plurality of directions.

### Solution to Problem

A road surface diagnosis system according to the present disclosure includes an acquisition means for acquiring a plurality of road surface images, a recognition means for recognizing road surface deterioration from each of the acquired road surface images, a conversion means for converting at least one of the plurality of road surface images in each of which road surface deterioration is recognized and in each of which a road surface at an identical site is imaged, a determination means for comparing the plurality of road surface images in each of which the road surface at the identical site is imaged, the plurality of road surface images including the converted road surface image, and determining whether road surface deterioration recognized from the road surface images is an identical road surface deterioration, and a display control means for displaying the recognized road surface deterioration as information indicating one road surface deterioration when the recognized road surface deterioration is determined to be identical road surface deterioration, and displaying the recognized road surface deterioration as information indicating different road surface deterioration when the recognized road surface deterioration is determined to be different road surface deterioration.

A road surface diagnosis method according to the present disclosure includes acquiring a plurality of road surface images, recognizing road surface deterioration from each of the acquired road surface images, converting at least one of the plurality of road surface images in each of which road surface deterioration is recognized and in each of which a road surface at an identical site is imaged, comparing the plurality of road surface images in each of which the road surface at the identical site is imaged, the plurality of road surface images including the converted road surface image, and determining whether road surface deterioration recognized from the road surface images is an identical road surface deterioration, and displaying the road surface deterioration as information indicating one road surface deterioration when the road surface deterioration is determined to be identical road surface deterioration, and displaying the road surface deterioration as information indicating different road surface deterioration when the road surface deterioration is determined to be different road surface deterioration.

A program according to the present disclosure causes a computer to execute the steps of acquiring a plurality of road surface images, recognizing road surface deterioration from each of the acquired road surface images, converting at least one of the plurality of road surface images in each of which road surface deterioration is recognized and in each of which a road surface at an identical site is imaged, comparing the plurality of road surface images in each of which the road surface at the identical site is imaged, the plurality of road surface images including the converted road surface image, and determining whether road surface deterioration recognized from the road surface images is an identical road surface deterioration, and displaying the road surface deterioration as information indicating one road surface deterioration when the road surface deterioration is determined to be identical road surface deterioration, and displaying the road surface deterioration as information indicating different road surface deterioration when the road surface deterioration is determined to be different road surface deterioration.

The program may be stored in a non-transitory computer-readable recording medium.

### Advantageous Effects of Invention

According to the present disclosure, it is possible to accurately diagnose a state of a road surface even when the road surface is imaged from a plurality of directions.

### BRIEF DESCRIPTION OF DRAWINGS

FIG. 1 is a block diagram illustrating a configuration example of a road surface diagnosis system according to the first example embodiment.

FIG. 2 is a diagram illustrating a display example of information indicating road surface deterioration.

FIG. 3 is a flowchart illustrating an operation example of the road surface diagnosis system according to the first example embodiment.

FIG. 4 is a diagram illustrating an outline of a device connected to the road surface diagnosis system.

FIG. 5 is a block diagram illustrating a configuration example of a road surface diagnosis system according to the second example embodiment.

FIG. 6 is a view illustrating an example of a display screen.

FIG. 7 is a diagram illustrating another example of the display screen.

FIG. 8 is a block diagram illustrating an example of a hardware configuration.

### EXAMPLE EMBODIMENT

### First Example Embodiment

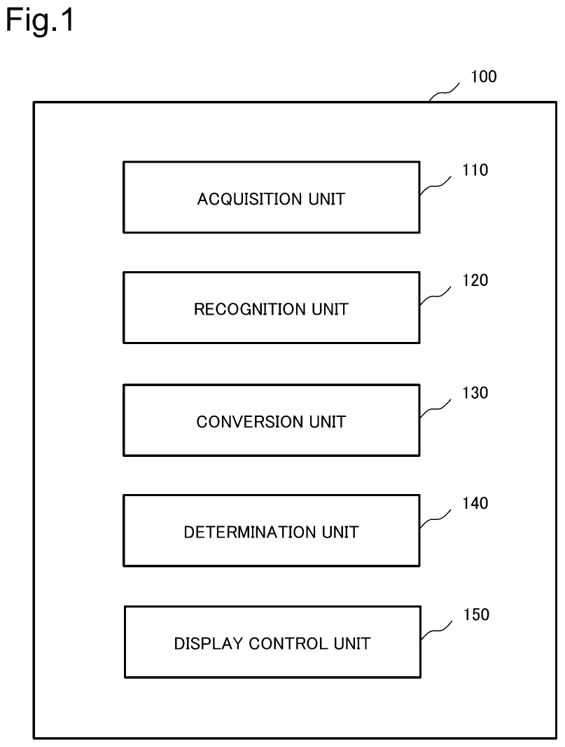

FIG. 1 is a block diagram illustrating a configuration example of a road surface diagnosis system 100 according to a first example embodiment. The road surface diagnosis system 100 includes an acquisition unit 110, a recognition unit 120, a conversion unit 130, a determination unit 140, and a display control unit 150.

The acquisition unit 110 acquires a plurality of road surface images. The road surface image is not particularly limited as long as the road surface deterioration recognized from the image can be compared. The road surface deterioration is damage caused on the road surface. The road surface image may be captured by a camera installed in a mobile object such as a vehicle, or may be captured by a camera installed at a road. Which range of the road surface image the acquisition unit 110 acquires can be appropriately set.

The acquisition unit 110 may acquire one or a plurality of moving images as the plurality of road surface images. The acquisition unit 110 may extract and acquire a plurality of still images from the moving image.

The recognition unit 120 recognizes road surface deterioration from each of the plurality of acquired road surface images. The recognition unit 120 recognizes road surface deterioration using a known image recognition technique for the road surface image. The recognition unit 120 may recognize the road surface deterioration using the learned model, but a recognition method is not particularly limited. The recognition unit 120 may recognize road surface deterioration by semantic segmentation.

The conversion unit 130 converts at least one of a plurality of road surface images in each of which the road surface deterioration is recognized and the road surface at the identical site is imaged. The conversion of the road surface image includes rotating the road surface image. The conversion of the road surface image may further include enlargement, reduction, or deformation of the road surface image.

The identical site is a site recognized to be approximately the identical. The identical site is, for example, a region represented by common position information. The identical site may be a region in which the values of the position information is within a predetermined range. For example, a value of position information by a global navigation satellite system (GNSS) or a global positioning system (GPS) may be used. Further, the identical site may be a region included in the identical section when the map is divided into sections of a predetermined size.

In a case where the identical road surface deterioration at the identical site is imaged a plurality of times, the shape of the imaged road surface deterioration is apparently different when the imaging directions are different. Therefore, there is a case where erroneous recognition occurs as to whether the images indicate the identical road surface deterioration. For example, the identical road surface deterioration may be recognized as two separate road surface deterioration states. When predetermined conversion is performed on at least one of the plurality of road surface images, there is a possibility that the apparent shapes of the road surface deterioration captured in the road surface image match with each other. As a result, the possibility of occurrence of erroneous recognition as to whether the images indicate the identical road surface deterioration. Therefore, the conversion unit 130 converts the road surface image used when the determination unit 140 determines whether the images indicate the identical road surface deterioration.

The determination unit 140 determines whether the road surface deterioration recognized from the plurality of road surface images is identical. The determination unit 140 compares a plurality of road surface images in each of which the road surface at the identical site is imaged, the plurality of road surface images including the road surface image converted by the conversion unit 130, and determines whether the road surface deterioration recognized from the road surface images is the identical road surface deterioration.

The determination unit 140 may determine whether the road surface deterioration is identical to another road surface deterioration every time the conversion unit 130 converts at least one of the road surface deterioration. The determination unit 140 may determine whether the road surface deterioration is identical to another road surface deterioration every time at least one of the road surface deteriorations is rotated in an any direction.

The conversion unit 130 may convert the road surface image indicating the road surface deterioration extracted from the road surface image. For example, the conversion unit 130 may convert a road surface image indicating a portion of road surface deterioration from the results of semantic segmentation. The determination unit 140 compares the road surface images indicating the portion of the road surface deterioration. The conversion unit 130 may convert the captured road surface image itself. The determination unit 140 compares the road surface deterioration recognized from the converted road surface image.

The display control unit 150 displays information indicating road surface deterioration recognized by the recognition unit 120. For example, the display control unit 150 displays an icon indicating the position of the road surface deterioration recognized by the recognition unit 120 on the map. For example, the display control unit 150 displays the icon at the position indicated by the position information of the site where the road surface image is captured.

When determined to be the identical road surface deterioration the display control unit 150 displays the identical road surface deterioration as information indicating one road surface deterioration. When determined to be different road surface deterioration, the display control unit 150 displays the road surface deterioration as information indicating the different road surface deterioration.

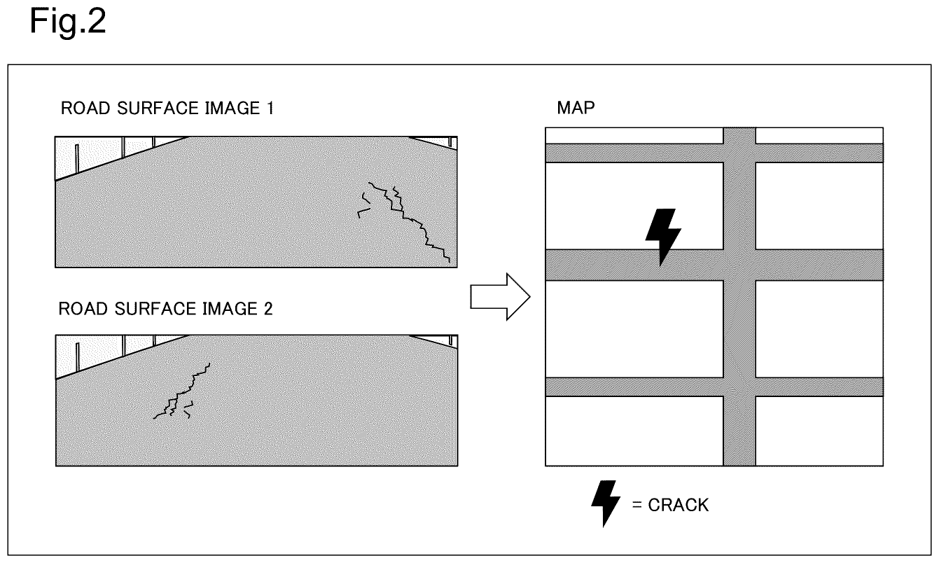

FIG. 2 is a diagram illustrating a display example of information indicating a road surface image and road surface deterioration recognized from the road surface image. The two road surface images in FIG. 2 are images in each of which the road surface at the identical site is imaged from a different direction. For example, based on the determination result as to whether the road surface deterioration is identical, the display control unit 150 displays one icon indicating the position of the road surface deterioration on the map for one road surface deterioration. In FIG. 2, since it is determined that the cracks included in the two road surface images are identical, one icon is displayed on the map. The display control unit 150 displays different road surface deterioration on the map with different icons. As a result, the display control unit 150 can prevent the identical road surface deterioration from being redundantly shown on the map.

The information indicating the road surface deterioration is not limited to the icons on the map. The display control unit 150 may display the road surface image in which the road surface deterioration is recognized as the information indicating the road surface deterioration. Another example of information indicating road surface deterioration will be described in a second example embodiment.

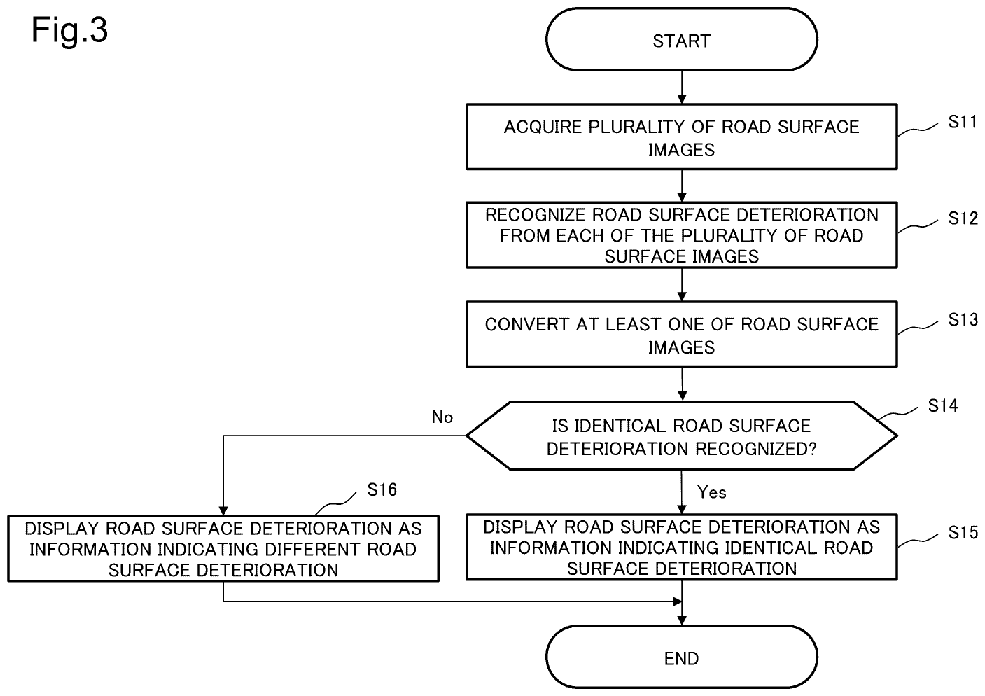

FIG. 3 is a flowchart illustrating an operation example of the road surface diagnosis system 100 according to the first example embodiment. The road surface diagnosis system 100 may start the operation of FIG. 3 according to the operation of the user using the input equipment.

The acquisition unit 110 acquires a plurality of road surface images (step S11). The recognition unit 120 recognizes road surface deterioration from each of the plurality of road surface images acquired by the acquisition unit 110 (step S12).

The conversion unit 130 converts at least one of a plurality of road surface images in each of which the recognition unit 120 has recognized road surface deterioration and the road surface at the identical site is imaged (step S13). The determination unit 140 compares the plurality of road surface images in each of which the road surface at the identical site is imaged, the plurality of road surface images including the converted road surface image, and determines whether the road surface deterioration recognized from the road surface images is the identical road surface deterioration (step S14).

When determined to be the identical road surface deterioration (step S14: Yes), the display control unit 150 displays the identical road surface deterioration as information indicating one road surface deterioration (step S15). When determined to be different road surface deterioration (step S14: No), the display control unit 150 displays the road surface deterioration as information indicating the different road surface deterioration (step S16). Thus, the road surface diagnosis system 100 ends the operation of FIG. 3.

The processing of step S13 and step S14 may be repeated. For example, every time the conversion unit 130 executes another conversion, the determination unit 140 makes a determination. When determined to be the identical road surface deterioration by any of the conversion processing, the process proceeds to step S15. After the repetition is performed until the predetermined condition is satisfied, when determined to be the different road surface deterioration, the process proceeds to step S16. The repetition conditions can be designed as appropriate. For example, the repetition condition may be that processing is executed a predetermined number of times, such as performing conversion and making determination 10 times. The repetition condition may be that conversion and determination are performed until at least one of the road surface images is rotated by one rotation.

According to the first example embodiment, the conversion unit 130 converts at least one of the plurality of road surface images in which the road surface deterioration is recognized. The determination unit 140 compares a plurality of road surface images in each of which the road surface at the identical site is imaged, the plurality of road surface images including the converted road surface image, and determines whether the road surface deterioration recognized from the road surface images is the identical road surface deterioration. Further, when determined to be the identical road surface deterioration, the display control unit 150 displays the identical road surface deterioration as information indicating one road surface deterioration. Therefore, the road surface deterioration recognized a plurality of times from a plurality of road surface images can be treated as the identical road surface deterioration. Therefore, even when the road surface is imaged from a plurality of directions, it is easy to accurately diagnose the state of the road surface.

### Second Example Embodiment

Regarding the configuration of the second example embodiment, description of the same configuration as that of the road surface diagnosis system 100 according to the first example embodiment will be omitted.

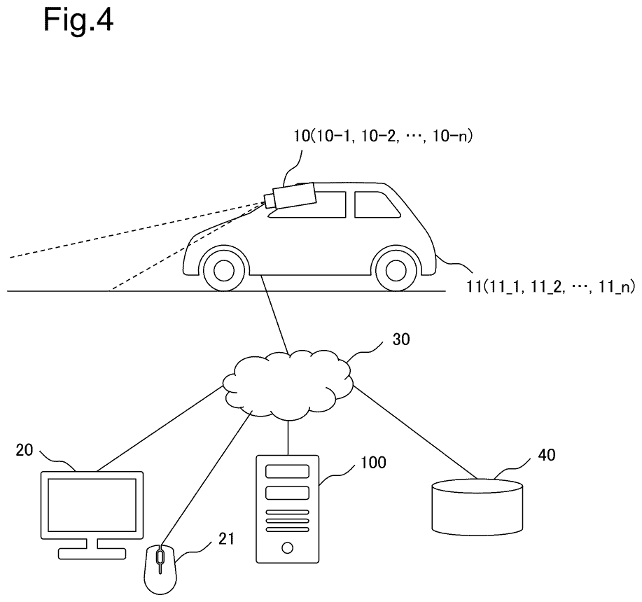

FIG. 4 is a diagram illustrating an outline of a device communicably connected to the road surface diagnosis system 100 in a wired or wireless manner via a communication network 30. The road surface diagnosis system 100 is connected to, for example, an imaging device 10, a display 20, an input equipment 21, and a database 40.

The imaging device 10 is installed in a mobile object 11 and captures an image. The imaging device 10 is achieved by, for example, a drive recorder mounted on an automobile. However, the type of the imaging device 10 is not limited thereto, and cameras provided in various types of mobile objects 11 may be used. For example, the image may be captured by a camera mounted on another mobile object such as a bicycle or a drone. In FIG. 4, the imaging device 10 is installed in such a way as to image a region in front of the mobile object 11. However, the direction in which the imaging device 10 is installed is not particularly limited.

The image captured by the imaging device 10 may be a still image or a moving image captured by the imaging device 10 while the mobile object 11 is moving. The image may be captured by a person or may be automatically captured at any intervals.

In FIG. 4, one imaging device 10 and one mobile object 11 are illustrated. However, the road surface diagnosis system 100 may be connected to a plurality of imaging devices 10-1, . . . , 11-n installed in a plurality of mobile objects 11-1, . . . , 10-n, respectively. n is a natural number equal to or more than 2.

Imaging data including an image captured by the imaging device 10 is stored in the database 40. The imaging device 10 may transmit imaging data including an image to road surface diagnosis system 100.

The imaging data may further include position information of a site where the image is captured. The position information includes, for example, position information by latitude and longitude, GNSS, or GPS, or a position on a map. The imaging data may include time information about the date and time when the image was captured and weather information of the imaging date and time.

Furthermore, the imaging data may include driving information of the mobile object 11 on which the imaging device 10 is mounted. The driving information includes, for example, a traveling direction, a speed, an acceleration, or a steering wheel operation of the mobile object 11. The driving information can be acquired using an any sensor such as a gyro sensor.

Furthermore, the imaging data may include an imaging direction in which an image is captured. The imaging direction includes, for example, an azimuth or an elevation angle in which the imaging device 10 is directed. The imaging direction can be acquired by a sensor provided in the imaging device 10. The imaging direction can be estimated based on the traveling direction of the mobile object 11 in a case where the installation direction of the imaging device 10 with respect to the mobile object 11 is defined. The traveling direction of the mobile object is acquired from, for example, time series data of position information of the mobile object or driving information.

The display 20 displays information to the user. The display 20 includes, for example, a display, a tablet, and the like. The information to be displayed will be described later.

The input equipment 21 receives an operation from a user. The input equipment 21 includes, for example, a mouse, a keyboard, and the like. In a case where the display 20 is a touch panel display, the display 20 may be configured as the input equipment 21.

The database 40 stores imaging data including an image captured by the imaging device 10.

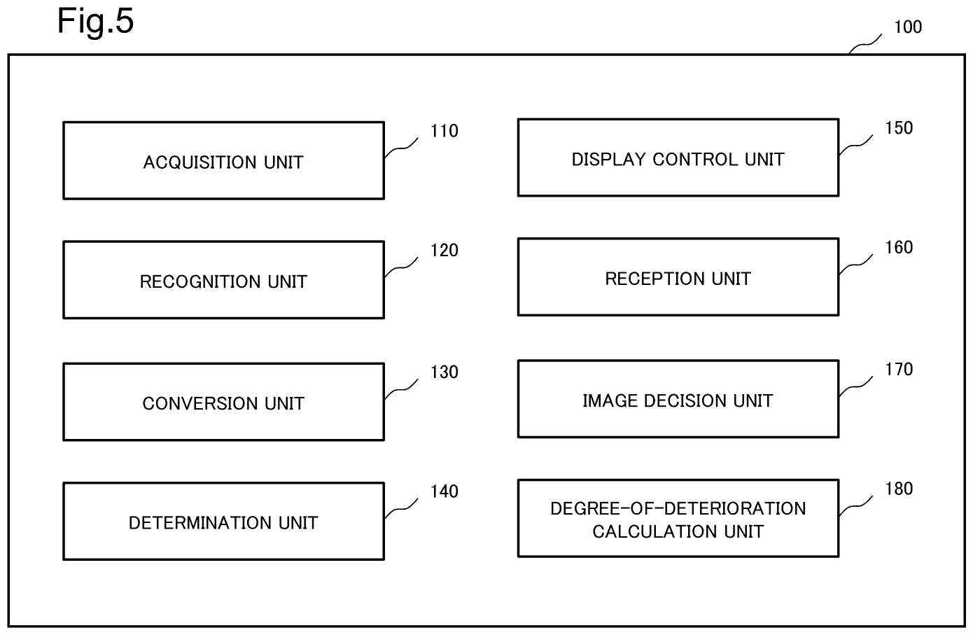

FIG. 5 is a block diagram illustrating a configuration example of the road surface diagnosis system 100 according to the second example embodiment. The road surface diagnosis system 100 according to the second example embodiment is different from that of the first example embodiment in that it further includes a reception unit 160, an image decision unit 170, and a degree-of-deterioration calculation unit 180. The reception unit 160, the image decision unit 170, and the degree-of-deterioration calculation unit 180 may be provided as necessary.

The acquisition unit 110 may acquire one or a plurality of moving images captured while one or a plurality of mobile objects 11 is each moving. The acquisition unit 110 may extract and acquire a still image from the moving image.

In an example, the acquisition unit 110 acquires a plurality of road surface images from database 40. In another example, the acquisition unit 110 may acquire the road surface image from imaging device 10 via the communication network 30. At this time, the road surface diagnosis system 100 is communicably connected to the imaging device 10 as necessary.

The acquisition unit 110 may acquire the imaging data including the road surface image. That is, the acquisition unit 110 may acquire position information, imaging date and time, driving information, and weather information of a site where the image is captured together with the road surface image.

The reception unit 160 receives an operation by the user. For example, the reception unit 160 receives an operation through the input equipment 21.

In the comparison of the road surface images, for example, the determination unit 140 performs matching of related points and shapes of road surface deterioration. The determination unit 140 may calculate the similarity of the road surface deterioration recognized from each road surface image using the matching result. The determination unit 140 determines whether the road surface deterioration recognized from each of the plurality of road surface images is identical based on the calculated similarity. For example, the determination unit 140 determines that the road surface deterioration is identical when any of the similarities calculated each time the road surface image is converted exceeds the threshold value. When at least one of the road surface deterioration is rotated, the similarity of the road surface deterioration may be the highest at a specific rotation angle. Therefore, the determination unit 140 may determine that the road surface deterioration is identical when the peak of the similarity exceeds the threshold value.

In a case where the plurality of mobile objects 11 images the identical site, when the traveling directions of the mobile objects 11 are different, the imaging directions are different, and the shapes of the road surface deterioration to be imaged are apparently different. Therefore, the conversion unit 130 converts the road surface image in such a way that the determination unit 140 can determine whether the shapes of the road surface deterioration match with each other.

The conversion unit 130 may convert the road surface image based on the imaging direction. The imaging direction used here may be the imaging direction included in the imaging data acquired by the acquisition unit 110 or the imaging direction estimated by the conversion unit 130 based on the driving information of the mobile object 11. For example, the conversion unit 130 estimates the imaging direction from the traveling direction or the steering wheel operation of the mobile object 11. From the imaging direction, it is possible to grasp in what direction the road surface deterioration recognized from the road surface image is imaged. Therefore, it is possible to grasp how to perform conversion in order to compare the road surface images. The conversion unit 130 may determine a range in which the road surface image is rotated based on the imaging direction. The conversion unit 130 rotates the road surface image within an appropriate range based on the imaging direction, thereby enabling more accurate determination as to whether the road surface deterioration is identical. It is possible to reduce calculation processing required for determination.

It is assumed that a certain mobile object 11 captures an image of a road surface while traveling north, and another mobile object 11 captures an image of a road surface while traveling south at the identical site on the opposite lane. The determination unit 140 determines whether the road surface deterioration captured in the north direction is identical to the road surface deterioration captured in the south direction. For this determination, the conversion unit 130 converts the road surface image in such a way that the road surface deterioration captured in the south direction appears to be captured in the north direction. For example, the conversion unit 130 rotates the road surface image by 180 degrees, and further deforms the road surface image in consideration of perspective. The determination unit 140 compares the road surface image captured in the north direction with the road surface image converted in the north direction. The determination unit 140 determines whether the road surface deterioration recognized from the road surface images is the identical road surface deterioration.

It is assumed that a plurality of mobile objects 11 images the road surfaces while traveling on different lanes in the identical direction. In this case, the determination unit 140 may determine whether the road surface deterioration is identical every time the conversion unit 130 rotates the road surface image by 5 degrees clockwise or counterclockwise by a predetermined number of times. With respect to the road surface images captured in the identical direction, the conversion unit 130 does not perform conversion of a predetermined degree or more. This is because, for example, even when the conversion unit 130 rotates the road surface image by 180 degrees and the shapes of the road surface deterioration match with each other, when the road surface image is captured in the identical direction, there is a high possibility that the road surface deterioration is different.

The determination unit 140 may determine that the road surface deterioration is identical when the similarity of the road surface deterioration between the road surface images to be compared exceeds a threshold value determined according to the length of the interval between the imaging dates and times of the road surface images. As the interval between the imaging days of the road surface image to be compared is longer, the road surface deterioration may progress. Therefore, even in the same road surface deterioration, the similarity is lowered. Therefore, based on the imaging date and time included in the imaging data, the determination unit 140 may lower the threshold value of the similarity for determining that the images indicate the identical road surface deterioration as the interval of the imaging date and time is longer.

The determination unit 140 may determine that the road surface deterioration is identical when the similarity of the road surface deterioration between the road surface images to be compared exceeds a threshold value determined according to the driving information including at least one of the traveling direction, the steering wheel operation, the speed, or the acceleration of the mobile object on which the imaging device that captures the road surface image is mounted.

A case in which the determination unit 140 changes the threshold value of the similarity of the road surface deterioration to be determined that the road surface deterioration is identical based on the driving information will be described. For example, the road surface image may be blurred depending on the speed and acceleration state of the mobile object 11. In a case where the speed is high, an overlapping portion in the imaging ranges of the plurality of road surface images identified by the same position information may be small. Therefore, even in a case where the identical road surface deterioration is captured, the similarity is lowered. Therefore, in a case where the speed or the acceleration of the mobile object 11 is larger than a predetermined degree, the determination unit 140 may lower the similarity threshold value.

Further, the determination unit 140 may change the threshold value of the similarity of the road surface deterioration to be determined that the road surface deterioration is identical, based on the imaging direction. The determination unit 140 may estimate the imaging direction based on driving information including the traveling direction and the steering wheel operation. In accordance with the closeness of the imaging direction, the determination unit 140 increases the threshold value for determining that the road surface deterioration is identical. This is because the similarity between two images obtained by imaging the identical range in close imaging directions increases. This is because, in a case where the imaging direction is greatly different, there is a possibility that road surface deterioration is converted in appearance different from actual appearance.

Furthermore, the determination unit 140 may change the threshold value for determining that the road surface deterioration is identical based on the degree of conversion of the road surface image by the conversion unit 130. Depending on the degree of conversion, the road surface deterioration may be deformed into a shape different from the shape of the actual road surface deterioration. For example, in order to easily detect the identical road surface deterioration, the determination unit 140 may change the threshold value to a lower value as the degree of conversion is larger.

The determination unit 140 may change the threshold value for determining that the road surface deterioration is identical based on the weather information at the time of imaging. Depending on sunshine conditions, the similarity can be calculated to be low even for the identical road surface deterioration. Therefore, when the weather at the time when the road surface image is captured is the same, the determination unit 140 changes the threshold value for determining that the road surface deterioration is identical to a higher value. In a case where the weather is different, the threshold value for determining that the road surface deterioration is identical weather is changed to a lower value.

The display control unit 150 may display information indicating road surface deterioration at the selected site based on selection of the site by the user. For example, the reception unit 160 receives a site selection operation by the user. For example, the display control unit 150 may display a determination result of the similarity of the road surface deterioration or as to whether the road surface deterioration is identical as the information indicating the road surface deterioration. The display control unit 150 may display one or a plurality of road surface images obtained by imaging the selected site and imaging date and time thereof as the information indicating the road surface deterioration.

The display control unit 150 may exclude the road surface image determined as different road surface deterioration from the display target. For example, when one of the five road surface images indicates different road surface deterioration, the display control unit 150 excludes the one from the display target. The display control unit 150 may group the road surface images for each identical road surface deterioration, and display the road surface images for each group. For example, there is a case where a group of two road surface images and a group of three road surface images indicate different road surface deterioration. In this case, the display control unit 150 displays the road surface image for each road surface deterioration.

The display control unit 150 may display some of the road surface images in each of which the recognized road surface deterioration is determined to be the identical road surface deterioration. For example, the display control unit 150 may display a road surface image captured at a newer date and time. The display control unit 150 may display a clearer road surface image. The clear road surface image is, for example, an unblurred image or an image in which more road surface deterioration can be recognized. More road surface deterioration can be recognized in a case where there is little shadow on the road surface due to sunshine conditions and there is no shielding object such as another vehicle or a fallen leaf. When the display control unit 150 displays the road surface image according to such a condition, the user does not need to see all the similar road surface images obtained by imaging the identical site.

When displaying the road surface image, the display control unit 150 may display the road surface image that has not been converted by the conversion unit 130. For example, when one road surface image is not converted and another road surface image is converted, the display control unit 150 may display the road surface image that is not converted. As a result, the user can grasp the road surface image used as the comparison reference. The display control unit 150 may display the road surface image before conversion for the road surface image to be converted. As a result, the user can grasp what road surface image was captured and used for comparison. The display control unit 150 may further display the road surface image converted by the conversion unit 130. As a result, the user can confirm the conversion accuracy of the deformed road surface image.

Next, another example of the information indicating the road surface deterioration displayed by the display control unit 150 will be described. For example, the display control unit 150 may display, as the information indicating the road surface deterioration, information indicating the certainty of the determination in the determination as to whether the road surface deterioration is identical. As the similarity of the road surface deterioration is farther from the threshold value, that is, as the similarity is clearly higher or lower than the threshold value, the certainty of the determination result of the determination unit 140 determining whether the road surface deterioration is identical is higher. As the similarity of the road surface deterioration is closer to the threshold value, the determination unit 140 may make an erroneous determination regardless of the determination result of whether the road surface deterioration is identical or not, and the certainty is low.

As the information indicating the certainty, the display control unit 150 may display the imaging site of the road surface image in which the road surface deterioration having a low certainty by the predetermined degree is recognized to be different from the imaging site of another road surface image. For example, the display control unit 150 may display an icon indicating a site whose certainty is lower than that of another site.

The display control unit 150 may display a value indicating the certainty or the similarity of the road surface deterioration as the information indicating the certainty of the determination. The display control unit 150 may display, as the information indicating the road surface deterioration, a road surface image at a site where the certainty of the determination is low among the road surface images determined as to whether the recognized road surface deterioration is identical. At this time, the display control unit 150 further displays a button for allowing the user to select whether the road surface deterioration is identical. The user checks the road surface image, the imaging date and time, the imaging condition, and the like displayed on the display 20. The user selects whether the road surface deterioration is identical using the input equipment 21. The reception unit 160 receives, from the user, a selection as to whether the road surface deterioration is identical. The determination unit 140 changes the determination result as to whether the road surface deterioration is identical based on the input from the user. When the determination result as to whether the road surface deterioration is identical is changed, the display control unit 150 displays information indicating the road surface deterioration according to the updated determination result.

The display control unit 150 may display the degree of damage of the road surface as the information indicating the road surface deterioration. The degree of damage of the road surface can be represented by various indexes. In the present disclosure, a degree of damage of a road surface is represented by a degree of deterioration.

When the degree of deterioration is calculated based on each of the plurality of road surface images obtained by imaging the same site, the user does not know which deterioration degree value should be referred to. Therefore, the image decision unit 170 determines which image is used to calculate the degree of deterioration among the road surface images obtained by imaging the identical site. The degree-of-deterioration calculation unit 180 calculates the degree of deterioration of the road surface based on the road surface image determined by the image decision unit 170.

As an example, the image decision unit 170 determines a road surface image to be used for calculating the degree of deterioration of the road surface at the site based on the determination result as to whether the road surface deterioration is identical. The image decision unit 170 may group the road surface images for each road surface image including the identical road surface deterioration. The image decision unit 170 may determine that the degree of deterioration is calculated using the group of the road surface images. The image decision unit 170 may determine any one of the road surface images in the group of the road surface images in which the identical road surface deterioration is recognized. For example, the image decision unit 170 determines a road surface image in which the road surface deterioration appears most clearly.

As another example, the image decision unit 170 may determine the road surface image based on the similarity of the road surface deterioration calculated by the determination unit 140. The image decision unit 170 may group the road surface images having the similarity of the road surface deterioration higher than the threshold value. The image decision unit 170 may determine to calculate the degree of deterioration using the group. As the threshold value of the similarity, a threshold value larger than or a threshold value smaller than a threshold value at which determination unit 140 determines that the road surface deterioration is identical may be used. In a case where a threshold value larger than the threshold value for determining that the road surface deterioration is identical is used, image decision unit 170 can group the road surface images that are more likely to include the identical road surface deterioration. When a threshold value lower than a threshold value for determining that the road surface deterioration is identical is used, the degree of deterioration can be calculated using more road surface images in the identical site.

The degree of deterioration may be any of indexes including the degree of cracking, the number of pot holes, the size of the pot hole, or the amount of rutting. The degree of deterioration may be determined based on a combination of a plurality of indexes indicating the degree of road deterioration. The degree of deterioration has a large value when the state of the road surface deteriorates. The manner of representing the degree of deterioration is not limited to this, and for example, the value of the degree of deterioration may be reduced when the state of the road surface deteriorates.

The degree of cracking is represented by any of a shape, a length, an area, the number, and the number of intersections of cracks recognized, or a combination thereof. The cracking rate is an example of the degree of cracking. The cracking rate is represented by, for example, 100× (crack area/road surface area). In this case, the value of the degree of deterioration ranges from 0% to 100%. The area of the crack is calculated by an any method. A method of calculating the cracking rate is not particularly limited, and a known calculation method can be applied in addition to the above.

The size of the pot hole is represented by, for example, any of an area, a width, a length, and a depth of the pot hole, or a combination thereof. The rutting amount is a depth of rutting at which a traveling track of the vehicle is lower than other road surfaces due to a load of the vehicle and friction with tires.

The degree-of-deterioration calculation unit 180 may calculate an average of the degrees of deterioration calculated from each of the plurality of road surface images. For example, the degree-of-deterioration calculation unit 180 may calculate an average of the degrees of deterioration calculated from the respective road surface images for a group of road surface images including the identical road surface deterioration. As a result, the degree-of-deterioration calculation unit 180 can accurately calculate the degree of deterioration based on a plurality of images obtained by capturing the same road surface deterioration.

The degree-of-deterioration calculation unit 180 may weight the degree of deterioration calculated from each of the plurality of road surface images based on the similarity between the road surface deterioration, and calculate the degree of deterioration of the site where the road surface image is captured based on the plurality of weighted deterioration degrees. That is, the degree-of-deterioration calculation unit 180 may calculate a weighted average of the degrees of deterioration. For example, the degree-of-deterioration calculation unit 180 lowers the weight of the degree of deterioration calculated from the road surface image in which the road surface deterioration having the low similarity is recognized. As a result, the degree-of-deterioration calculation unit 180 can calculate the degree of deterioration of the road surface including certain road surface deterioration with high accuracy by lowering the weight of the degree of deterioration based on the road surface image having a low certainty of including the identical road surface deterioration.

When a plurality of road surface deteriorations is included in the identical site, the degree-of-deterioration calculation unit 180 may calculate an average of the deterioration degrees calculated from the road surface images including the respective road surface deteriorations. As a result, the average degree of deterioration of the road surface in the identical site can be calculated.

The display control unit 150 displays the degree of deterioration calculated by the degree-of-deterioration calculation unit 180. In a case where one value of the degree of deterioration is displayed for one site, the user can easily grasp the degree of deterioration. The display control unit 150 may display a plurality of deterioration degrees for one site. For one site, the degree of deterioration calculated from the road surface image may be different depending on the range to be captured. Therefore, by displaying the degree of deterioration for each range, the user can accurately grasp the deterioration state of the site.

Further, when the determination result is changed, the degree-of-deterioration calculation unit 180 recalculates the degree of deterioration assuming that the road surface image indicates different road surface deterioration. Alternatively, the degree-of-deterioration calculation unit 180 recalculates the degree of deterioration by merging the same road surface deterioration. For example, when the degree of deterioration is calculated assuming that pot holes recognized from a plurality of road surface images obtained by imaging the identical site are different from each other, the degree of deterioration of the site is calculated to be higher than that in a case where the degree of deterioration is calculated as a single pot hole. The degree-of-deterioration calculation unit 180 calculates the degree of deterioration by merging the same road surface deterioration, so that it is possible to prevent the degree of deterioration from being calculated higher than actual.

An example of the display screen will be described for the information displayed by the display control unit 150 described above.

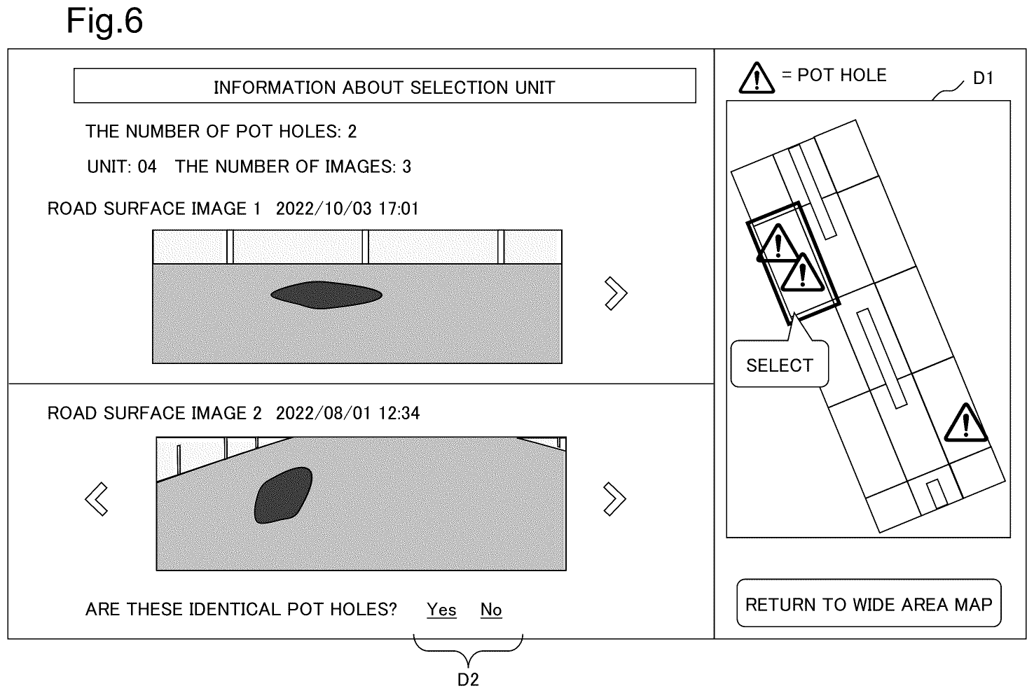

FIG. 6 is a diagram illustrating an example of a display screen displayed by the display control unit 150. FIG. 6 illustrates a case where two pot holes recognized from images equal to or more than two obtained by imaging the identical site are determined to have different road surface deterioration. The map D1 is a map obtained by dividing a road surface of several meters into rectangular units. The unit is an example of a management unit of the road surface. The identical unit may be treated as the identical site. On the map D1, the display control unit 150 displays two triangular icons indicating the positions of the pot holes in one unit.

A site (unit) including the pot holes is selected on the map D1. Therefore, the display control unit 150 displays the degree of deterioration (the number of pot holes: 2) at the selected site, the road surface image, and the imaging date and time of the image. The display screen of FIG. 6 includes a button D2 for allowing the user to input whether the road surface deterioration is identical. In response to the question “ARE THESE IDENTICAL POT HOLES?”, the user compares the road surface deterioration in the road surface image. When the user inputs “Yes” of the button D2, the determination unit 140 determines that the two pot holes have the identical road surface deterioration. Then, the display control unit 150 integrates the icons displayed on the map into one, and updates the degree of deterioration.

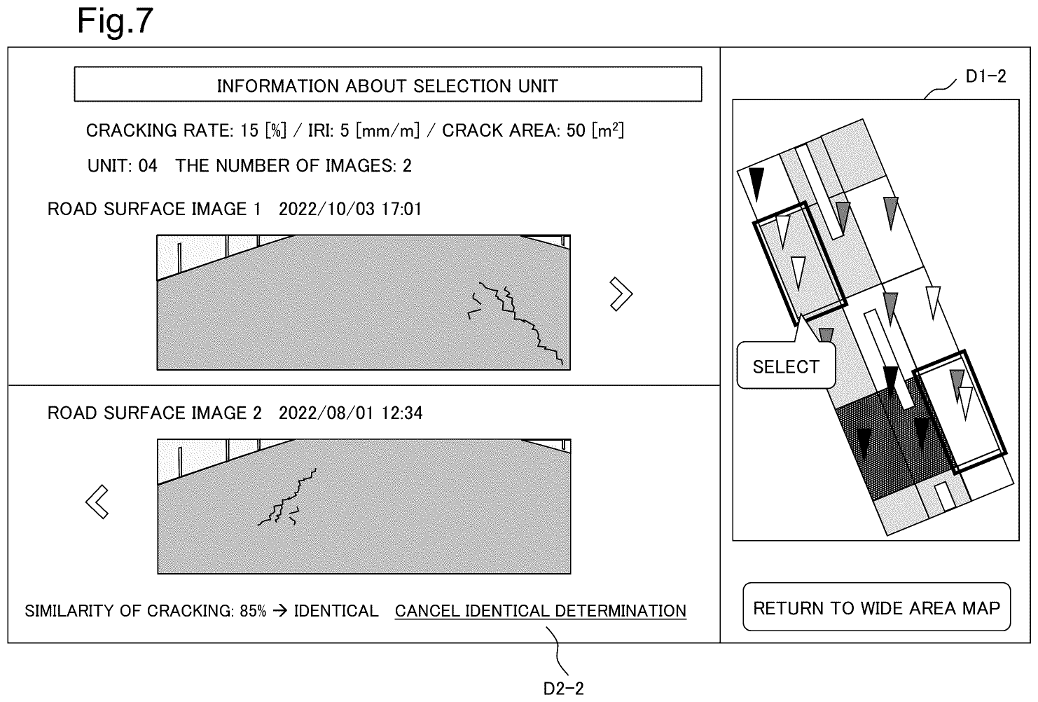

FIG. 7 is a diagram illustrating another example of the display screen displayed by the display control unit 150. FIG. 7 illustrates a case where it is determined that cracks recognized from images equal to or more than two obtained by imaging the identical site (the identical unit) are the identical crack. In the map D1-2 of FIG. 7, an inverted triangle indicates a site where the road surface image is captured. The color of each inverted triangle represents the level of the degree of deterioration calculated from the road surface image. In the map D1-2, the color of each unit represents the level of the degree of deterioration calculated for each unit.

On the map D1-2, one site (unit) is selected. The display screen of FIG. 7 includes the degree of deterioration, the road surface image, and the imaging date and time of the selected site. In the example of FIG. 7, a plurality of units may be selected. In this case, the display control unit 150 may display the information about the road surface deterioration included in the plurality of selected units.

The display screen of FIG. 7 also includes a button D2-2 that allows the user to input whether the road surface deterioration is identical. The user compares the road surface deterioration in the road surface image in consideration of the date and time when the road surface image was captured. When the user inputs the button D2-2 indicating that “CANCEL THE IDENTICAL DETERMINATION”, the determination unit 140 determines that the cracks included in the respective road surface deteriorations have different road surface deteriorations.

According to the second example embodiment, the same effects as those of the first example embodiment can be obtained. Further, according to the second example embodiment, the image decision unit 170 determines the road surface image to be used for calculation of the degree of deterioration based on the similarity, and the degree-of-deterioration calculation unit 180 calculates the degree of deterioration of the road surface from the determined road surface image. The determination unit 140 changes the determination result as to whether the road surface deterioration is identical based on the input from the user. Therefore, it is possible to display the diagnosis result of the road surface according to the actual road surface deterioration state.

### Modifications

The above-described example embodiments can be modified as follows, for example.

The imaging data used by the road surface diagnosis system 100 may include the measurement result of the flatness of the site where the image is captured. The flatness may be represented by an International Roughness Index (IRI). The IRI is an index in which the road surface and the ride comfort of the driver are associated with each other, and represents the degree of unevenness as a numerical value.

When deterioration is not progressing, it is assumed that substantially the same measurement result can be obtained when IRI at the same site is measured a plurality of times. Therefore, as the image obtained by imaging the identical site, an image having substantially the identical value of IRI (mm/m) measured at the time of imaging the image may be used. Even when there is an error in the value of IRI, the image of the site may be used on the assumption that the values are identical. The substantially identical range and the allowable range of the error may be appropriately determined according to the deterioration situation and the situation of the measurement site.

The acquisition unit 110 may extract and acquire a plurality of road surface images obtained by imaging the identical site from one or a plurality of moving images. For example, the acquisition unit 110 extracts a plurality of road surface images based on the position information. Alternatively, the acquisition unit 110 may acquire the images regardless of whether the road surface images are at the identical site in acquiring the plurality of road surface images. That is, the acquisition unit 110 acquires a plurality of road surface images at a plurality of sites including a plurality of road surface images obtained by imaging the identical site. The conversion unit 130 may extract road surface images obtained by imaging the identical site, and convert at least one of the road surface images.

In addition to the road surface deterioration, the road surface diagnosis system 100 may use an object other than the road surface deterioration such as a road surface marking for determining whether the road surface deterioration is identical. The recognition unit 120 recognizes a road surface marking or the like from each of the plurality of road surface images. The determination unit 140 compares the road surface images at the identical site, the plurality of road surface images including the converted road surface image, and determines whether the road surface markings are identical. For example, the determination unit 140 calculates the similarity of the road surface markings for each of the road surface markings recognized from each of the plurality of road surface images, as in the road surface deterioration. When the similarity with each of the converted road surface deterioration and the road surface marking exceeds the threshold value, the determination unit 140 determines that the road surface deterioration recognized from each of the plurality of road surface images is identical.

### Hardware Configuration

In each of the above-described example embodiments, each component of the road surface diagnosis system 100 represents a block of functional units. Some or all of the components of the road surface diagnosis system 100 may be achieved by an any combination of the computer 500 and a program.

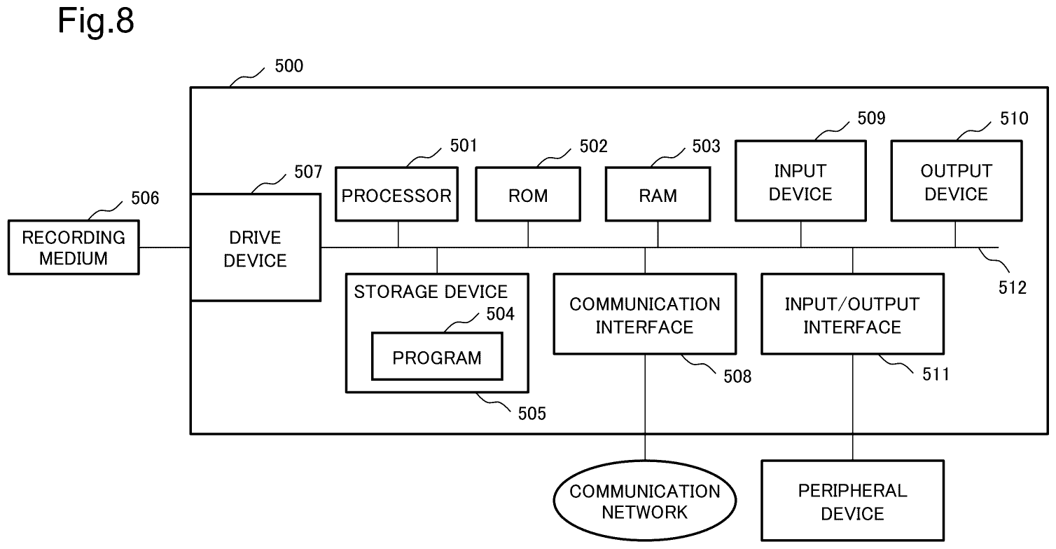

FIG. 8 is a block diagram illustrating an example of a hardware configuration of the computer 500. Referring to FIG. 8, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes instructions for implementing the functions of the road surface diagnosis system 100. The program 504 is stored in advance in the ROM 502, the RAM 503, and the storage device 505. The processor 501 implements each function of the road surface diagnosis system 100 by executing a command included in the program 504. The RAM 503 may store data processed in each function of the road surface diagnosis system 100. For example, the captured image may be stored in the RAM 503 of the computer 500.

The drive device 507 reads and writes the recording medium 506. The communication interface 508 provides an interface with a communication network. The input device 509 is, for example, a mouse, a keyboard, or the like, and receives an input of information from an administrator or the like. The output device 510 is, for example, a display, to output (displays) information to an administrator or the like. The input/output interface 511 provides an interface with a peripheral device. The bus 512 connects the components of the hardware. The program 504 may be supplied to the processor 501 via a communication network, or may be stored in the recording medium 506 in advance, read by the drive device 507, and supplied to the processor 501.

The hardware configuration illustrated in FIG. 8 is an example, and other components may be added or some components may not be included.

There are various modifications of the method of implementing the road surface diagnosis system 100. For example, the road surface diagnosis system 100 may be achieved by an any combination of a computer and a program different for each component. The plurality of components included in the road surface diagnosis system 100 may be achieved by an any combination of one computer and a program.

At least part of the road surface diagnosis system 100 may be provided in a software as a service (Saas) format. That is, at least part of the functions for implementing the road surface diagnosis system 100 may be executed by software executed via a network.

While the present disclosure has been particularly illustrated and described with reference to example embodiments thereof, the present disclosure is not limited to these example embodiments. Various modifications that can be understood by those of ordinary skill in the art can be made to the configuration and details of the present disclosure within the scope of the present disclosure. The configurations in the respective example embodiments can be combined with each other without departing from the scope of the present disclosure.

Some or all of the above example embodiments may be described as the following Supplementary Notes, but are not limited to the following.

### Supplementary Note 1

A road surface diagnosis system including
an acquisition means for acquiring a plurality of road surface images,
a recognition means for recognizing road surface deterioration from each of the acquired road surface images,
a conversion means for converting at least one of the plurality of road surface images in each of which road surface deterioration is recognized and in each of which a road surface at an identical site is imaged,
a determination means for comparing the plurality of road surface images in each of which the road surface at the identical site is imaged, the plurality of road surface images including the converted road surface image, and determining whether road surface deterioration recognized from the road surface images is an identical road surface deterioration, and
a display control means for displaying the recognized road surface deterioration as information indicating one road surface deterioration when the recognized road surface deterioration is determined to be identical road surface deterioration, and displaying the recognized road surface deterioration as information indicating different road surface deterioration when the recognized road surface deterioration is determined to be different road surface deterioration.

### Supplementary Note 2

The road surface diagnosis system according to Supplementary Note 1, wherein
the information indicating the road surface deterioration includes information indicating certainty of determination in determining whether the road surface deterioration is identical.

### Supplementary Note 3

The road surface diagnosis system according to Supplementary Note 2, wherein
the information indicating the certainty is an icon indicating a site having the certainty lower than a certainty of another site on a map.

### Supplementary Note 4

The road surface diagnosis system according to Supplementary Note 2 or 3, wherein
the information indicating the road surface deterioration is a road surface image at a site where the certainty is low among road surface images in which it is determined whether the recognized road surface deterioration is identical.

### Supplementary Note 5

The road surface diagnosis system according to any one of Supplementary Notes 1 to 4, further including
a reception means for receiving, from a user, selection as to whether road surface deterioration is identical, wherein
the determination means changes determination as to whether the road surface deterioration is identical according to the received selection.

### Supplementary Note 6

The road surface diagnosis system according to any one of Supplementary Notes 1 to 5, wherein
the information indicating the road surface deterioration is a road surface image captured at a later date and time among road surface images in which the recognized road surface deterioration is determined to be identical road surface deterioration.

### Supplementary Note 7

The road surface diagnosis system according to any one of Supplementary Notes 1 to 6, wherein
the conversion means estimates, based on a traveling direction of a mobile object on which an imaging device is mounted or driving information including a steering wheel operation, an imaging direction of the imaging device that captures the road surface image, and converts the road surface image based on the estimated imaging direction.

### Supplementary Note 8

The road surface diagnosis system according to Supplementary Note 7, wherein
the conversion means rotates the road surface image based on the driving information.

### Supplementary Note 9

The road surface diagnosis system according to any one of Supplementary Notes 1 to 7, wherein
the determination means determines that the road surface deterioration is identical when similarity of road surface deterioration between road surface images to be compared exceeds a threshold value determined according to a length of an interval between imaging dates and times of the road surface images.

### Supplementary Note 10

The road surface diagnosis system according to any one of Supplementary Notes 1 to 9, wherein
the determination means determines that the road surface deterioration is identical when similarity of the road surface deterioration between road surface images to be compared exceeds a threshold value determined according to driving information including at least one of a traveling direction, a steering wheel operation, a speed, or an acceleration of a mobile object on which an imaging device that captures the road surface images is mounted.

### Supplementary Note 11

The road surface diagnosis system according to any one of Supplementary Notes 1 to 10, wherein
the display control means displays a position of identical road surface deterioration on a map with one icon.

### Supplementary Note 12

The road surface diagnosis system according to any one of Supplementary Notes 1 to 11, further including
a degree-of-deterioration calculation means for weighting a degree of deterioration calculated from each of the plurality of road surface images based on similarity between road surface deterioration, and calculating a degree of deterioration at a site where the each road surface image is captured based on a plurality of the weighted degrees of deterioration.

### Supplementary Note 13

A road surface diagnosis method including
acquiring a plurality of road surface images,
recognizing road surface deterioration from each of the acquired road surface images,
converting at least one of the plurality of road surface images in each of which road surface deterioration is recognized and in each of which a road surface at an identical site is imaged,
comparing the plurality of road surface images in each of which the road surface at the identical site is imaged, the plurality of road surface images including the converted road surface image, and determining whether road surface deterioration recognized from the road surface images is an identical road surface deterioration, and
displaying the road surface deterioration as information indicating one road surface deterioration when the road surface deterioration is determined to be identical road surface deterioration, and displaying the road surface deterioration as information indicating different road surface deterioration when the road surface deterioration is determined to be different road surface deterioration.

### Supplementary Note 14

A recording medium that non-transiently records a program for causing a computer to execute the steps of
acquiring a plurality of road surface images,
recognizing road surface deterioration from each of the acquired road surface images,
converting at least one of the plurality of road surface images in each of which road surface deterioration is recognized and in each of which a road surface at an identical site is imaged,
comparing the plurality of road surface images in each of which the road surface at the identical site is imaged, the plurality of road surface images including the converted road surface image, and determining whether road surface deterioration recognized from the road surface images is an identical road surface deterioration, and
displaying the road surface deterioration as information indicating one road surface deterioration when the road surface deterioration is determined to be identical road surface deterioration, and displaying the road surface deterioration as information indicating different road surface deterioration when the road surface deterioration is determined to be different road surface deterioration.

### REFERENCE SIGNS LIST

100 road surface diagnosis system
110 acquisition unit
120 recognition unit
130 conversion unit
140 determination unit
150 display control unit
160 reception unit
170 image decision unit
180 degree-of-deterioration calculation unit
10 imaging device
11 mobile object
20 display
21 input equipment
30 communication network
40 database

What is claimed is:

1. A road surface diagnosis system comprising:
at least one memory storing instructions; and
at least one processor configured to execute the instructions to:
acquire a plurality of road surface images;
recognize road surface deterioration from each of the acquired road surface images;
convert at least one of the plurality of road surface images;
compare the plurality of road surface images in each of which the road surface at the identical site is imaged, the plurality of road surface images including the converted road surface image, and determine whether road surface deterioration recognized from the road surface images is an identical road surface deterioration; and
display, based on the determination, information of the recognized road surface deterioration as information indicating one road surface deterioration or information indicating different road surface deterioration.

2. The road surface diagnosis system according to claim 1, wherein the at least one processor is further configured to execute the instructions to:
display the information indicating the road surface deterioration including information indicating certainty of determination in determining whether the road surface deterioration is identical.

3. The road surface diagnosis system according to claim 2, wherein the at least one processor is further configured to execute the instructions to:
display the information indicating the certainty with an icon indicating a site having the certainty lower than a certainty of another site on a map.

4. The road surface diagnosis system according to claim 2, wherein the at least one processor is further configured to execute the instructions to:
display the information indicating the road surface deterioration including a road surface image at a site where the certainty is low among road surface images in which it is determined whether the recognized road surface deterioration is identical.

5. The road surface diagnosis system according to claim 1, wherein the at least one processor is further configured to execute the instructions to:
receive, from a user, selection as to whether road surface deterioration is identical, and
change determination as to whether the road surface deterioration is identical according to the received selection.

6. The road surface diagnosis system according to claim 1, wherein the at least one processor is further configured to execute the instructions to:
display the information indicating the road surface deterioration including a road surface image captured at a later date and time among road surface images in which the recognized road surface deterioration is determined to be identical road surface deterioration.

7. The road surface diagnosis system according to claim 1, 6, wherein the at least one processor is further configured to execute the instructions to:
estimate, based on a traveling direction of a mobile object on which an imaging device is mounted or driving information including a steering wheel operation, an imaging direction of the imaging device that captures the road surface image; and
convert the road surface image based on the estimated imaging direction.

8. The road surface diagnosis system according to claim 7, wherein the at least one processor is further configured to execute the instructions to:
rotate the road surface image based on the driving information.

9. The road surface diagnosis system according to claim 7, 7, wherein the at least one processor is further configured to execute the instructions to:
determine that the road surface deterioration is identical when similarity of road surface deterioration between road surface images to be compared exceeds a threshold value determined according to a length of an interval between imaging dates and times of the road surface images.

10. The road surface diagnosis system according to claim 1, 9, wherein the at least one processor is further configured to execute the instructions to:
determine that the road surface deterioration is identical when similarity of the road surface deterioration between road surface images to be compared exceeds a threshold value determined according to driving information including at least one of a traveling direction, a steering wheel operation, a speed, or an acceleration of a mobile object on which an imaging device that captures the road surface images is mounted.

11. The road surface diagnosis system according to claim 1, wherein the at least one processor is further configured to execute the instructions to:
display a position of identical road surface deterioration on a map with one icon.

12. The road surface diagnosis system according to claim 1, wherein the at least one processor is further configured to execute the instructions to:
weigh a degree of deterioration calculated from each of the plurality of road surface images based on similarity between road surface deterioration; and
calculate a degree of deterioration at a site where the each road surface image is captured based on a plurality of the weighted degrees of deterioration.

13. A road surface diagnosis method comprising:
acquiring a plurality of road surface images;
recognizing road surface deterioration from each of the acquired road surface images;
converting at least one of the plurality of road surface images;
comparing the plurality of road surface images in each of which the road surface at the identical site is imaged, the plurality of road surface images including the converted road surface image, and determining whether road surface deterioration recognized from the road surface images is an identical road surface deterioration; and
displaying, based on the determination, information of the road surface deterioration as information indicating one road surface deterioration or information indicating different road surface.

14. A non-transitory computer-readable recording medium that records a program for causing a computer to execute the steps of:
acquiring a plurality of road surface images;
recognizing road surface deterioration from each of the acquired road surface images;
converting at least one of the plurality of road surface images;
comparing the plurality of road surface images in each of which the road surface at the identical site is imaged, the plurality of road surface images including the converted road surface image, and determining whether road surface deterioration recognized from the road surface images is an identical road surface deterioration; and
displaying, based on the determination, information of the road surface deterioration as information indicating one road surface deterioration or information indicating different road surface.
